(19) United States
(12) Patent Application Publication
(10) Pub. No.: US 2014/0285968 A1
(43) Pub. Date: Sep. 25, 2014

(54) Frame and Handles for Holding a Computer

(71) Applicant: Michael Budge, Los Angeles, CA (US)

(72) Inventor: Michael Budge, Los Angeles, CA (US)

(21) Appl. No.: 14/186,563

(22) Filed: Feb. 21, 2014

Related U.S. Application Data
(63) Continuation-in-part of application No. 13/849,907, filed on Mar. 25, 2013.

(51) Int. Cl. F16M 13/04; A45F 5/10; G06F 1/16

(52) U.S. Cl. CPC F16M 13/04; G06F 1/1613; A45F 5/102
USPC 361/679.56; 294/137

(57) ABSTRACT

An apparatus may be used with a notebook, tablet, mobile phone, computer, or other device to provide handles for securely and comfortably holding and manipulating the notebook. The apparatus generally includes a frame, a pair of handles, and a case approximately the size of the notebook. The apparatus may be removably secured to the notebook by gripping edges of the notebook so that the notebook may be manipulated and handled by the handles of the apparatus, and while secured may retain functionality of the notebook. The frame may include a rib for connecting the handles with the case, as well as connecting the handles to each other, and may provide stability and strength to the apparatus. In another aspect, the apparatus may be a unitary structure including a body, one or more handles, and one or more connectors connecting the handles to the body.

### CROSS REFERENCE TO RELATED APPLICATIONS

This application is a continuation-in-part application of U.S. patent application Ser. No. 13/849,907, filed Mar. 25, 2013. U.S. patent application Ser. No. 13/849,907 is hereby incorporated by reference in its entirety.

### BACKGROUND

No federally sponsored research or development, and no sequence listing, table, or computer program listing compact disc appendix is applicable to this application.

The present disclosure relates to the field of computer accessories. More particularly, the present disclosure relates to an apparatus for use with a notebook (or tablet, tablet PC, iPad, mobile phone, cell phone, smart phone, etc.) whereby the apparatus may be removably secured to the notebook by gripping edges of the notebook so that the notebook may be manipulated and handled by handles of the apparatus.

Use of tablet computers (“tablets”) is increasingly prevalent throughout the United States and rest of the world. Tablets are a rapidly growing segment of mobile devices. Holding a tablet can cause fatigue for a user's hands or arms, which in turn may increase the risk of dropping the tablet. Among other benefits, tablets are useful for recording live events. However, holding a tablet for recording purposes may especially cause such fatigue or risk of dropping the tablet, especially when holding the tablet above one's head or in other positions to capture a desired view.

A number of configurations exist wherein a frame is used to hold a tablet or notebook or for protection against hard contacts and for securing one or more handles for manipulating the notebook. However, there does not exist a frame and case combination having spaced apart handles connected by a rib embedded in the case, or a unitary structure having a body, connector, and handle, whereby gripping portions of the case are removably secured to edges of a notebook, which provides protection for the notebook and ease of holding and manipulating such notebook, while still permitting complete (or nearly complete) functionality.

The apparatus of this disclosure overcomes the above problems and has further advantages as described in the following detailed description and related drawing figures.

### BRIEF SUMMARY AND OBJECTIVES

The present disclosure describes a new and novel apparatus for carrying, holding, and securing a tablet PC, notebook, smart phone, or other computer device.

An advantage of the present method is to prevent or reduce fatigue from holding the notebook.

Another advantage is to add a protective surface and body to the notebook.

Another advantage is to reduce a risk of dropping the notebook.

Another advantage is the relative ease with which the notebook is secured to the case.

Another advantage is that a notebook may remain fully (or mostly) functional while engaged with the structure.

The details of one or more embodiments of these concepts are set forth in the accompanying drawings and the description below. Other features, objects, and advantages of these concepts will be apparent from the description and drawings, and from the claims.

### BRIEF DESCRIPTION OF THE FIGURES

FIGS. 1-5 show an exemplary apparatus (or features thereof) according a first aspect of the invention.

FIG. 1 is a plan front view showing an exemplary apparatus according to the present disclosure;

FIG. 2 is a plan rear view of the exemplary apparatus;

FIG. 3 is a perspective view of a frame of the exemplary apparatus;

FIG. 4 is a cross-sectional view of the exemplary apparatus; and

FIG. 5 is a cross-sectional view of a handle of the exemplary apparatus.

FIGS. 6-11 show an exemplary apparatus (or features thereof) according to a second aspect of the invention.

FIG. 6 is a perspective view showing an exemplary apparatus according to the present disclosure.

FIG. 7 is a plan front view of the exemplary apparatus;

FIG. 8 is a plan front view of the exemplary apparatus engaged with an exemplary notebook.

FIG. 9 is a plan rear view of the exemplary apparatus;

FIG. 10 is a plan rear view of the exemplary apparatus engaged with the exemplary notebook; and

FIGS. 11A-B are cross-sectional views of an exemplary gripping portion of the apparatus.

Like reference symbols in the various drawings indicate like elements.

### DETAILED DESCRIPTION

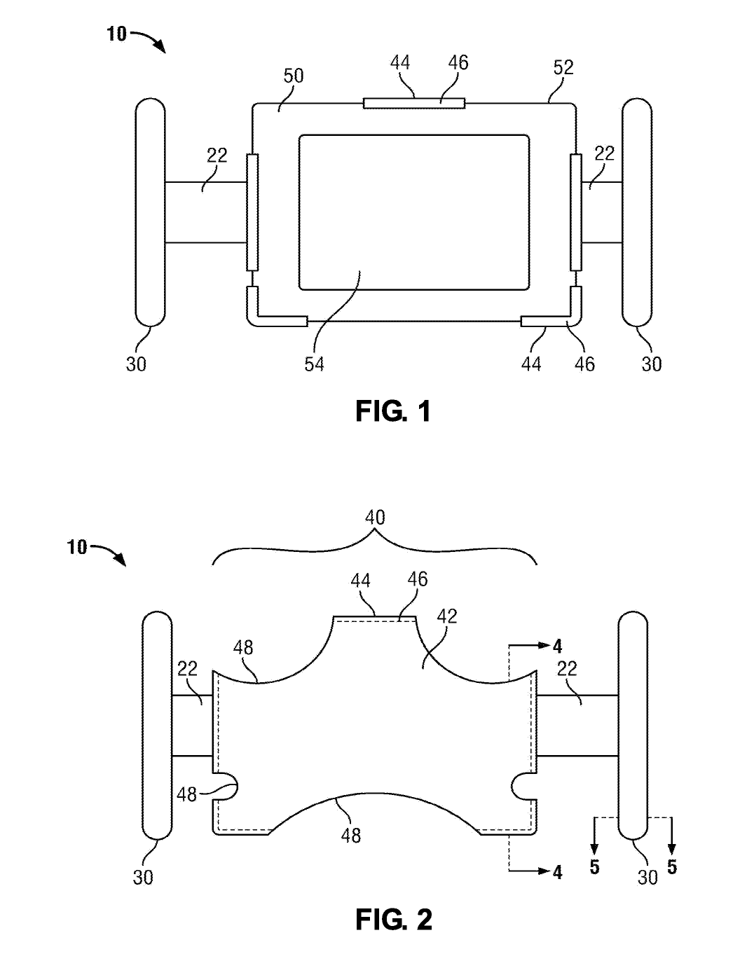

FIG. 1 is a front view of an exemplary apparatus 10 according to the present disclosure. As shown in FIG. 1, apparatus 10 may include a pair of handles 30 at opposite sides of apparatus 10, handles 30 oriented in a first direction. A connecting rib 22 may have a length extensive between handles 30 and may be oriented in a second direction. The second direction may be perpendicular to the first direction.

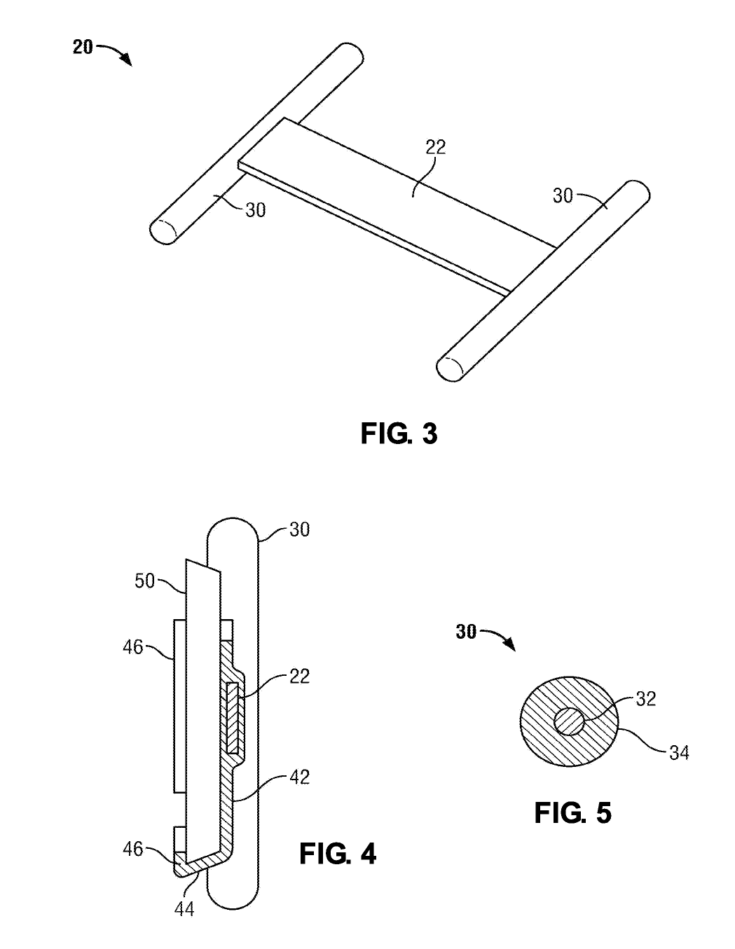

Connecting rib 22 may be part of a frame 20 (see FIG. 3). In one aspect, a single handle 30 is provided. In such aspect, rib 22 may extend from single handle 30 to a side of a case 40 (see FIG. 2) opposite from single handle 30. Rib 22 is generally a sheet or strip of metal or other material of sufficient rigidity to provide strength to apparatus 10.

Rib 22 generally has a width sufficient to impart strength to apparatus 10, but narrow enough to avoid obscuring buttons, controls, or other functional elements of a notebook 50. Multiple ribs 22 extensive between handles 30 may also serve these purposes.

Notebook 50 is held and gripped by apparatus 10. Specifically, notebook 50 may be held and gripped by case 40 (see FIG. 2). Notebook 50 generally has a screen 54 in a central area of notebook 50 and notebook edges 52 along a periphery of notebook 50. Case 40 is between handles 30 and may include a body portion 42 (see FIG. 2), peripheral edges 44, and gripping portions 46. As shown in FIG. 1, when notebook 50 is engaged with apparatus 10, only peripheral edges 44 and gripping portions 46 may be visible from a front view of apparatus 10.

Gripping portions 46 wrap around notebook edges 52 to engage notebook 50 with apparatus 10. Case 40 may be formed of a hard material, such as plastic or other polymer having a generally rigid character. However, case 40 should be sufficiently elastic to allow a small degree of expansion or contraction of a space between body portion 42 and gripping portion 46. The elasticity permits notebook 50 to snap or lock into place within case 40. Consequently, a compressive force may be exerted upon notebook edge 52 by gripping portion 46 and body portion 42 at an opposite side of notebook 50 from gripping portion 46. Case 40 is preferably transparent, thus allowing a design on a backside of notebook 50 to remain visible when notebook 50 is engaged with case 40.

FIG. 2 is a rear view of apparatus 10, shown without notebook 50. As shown in FIG. 2, case 40 may include body portion 42, peripheral edges 44, and gripping portions 46. Case 40 may also include recessed portions 48. Recessed portions 48 may expose buttons, controls, or other functional elements of notebook 50 such that the buttons, controls or elements remain accessible and functional to a user of notebook 50. The location, size, shape, width, and number of recessed portions 48 may be selected based upon a particular configuration of the notebook 50 to be engaged with apparatus 10.

As shown in FIG. 2, handles 30 may have a length equal or substantially equal to a length of case 40. However, handles 30 may extend beyond the length of case 40. In such case, the handles may provide greater protection by increasing the likelihood of a handle 30 being struck against the ground or another object rather than case 40 or notebook 50. Conversely, handles 30 may not be extensive with a length of case 40, in order to provide more compact handles 30 for easier storage of apparatus 10 or for a less cumbersome overall size of apparatus 10.

FIG. 3 is a perspective view of frame 20, which may include rib 22 and handles 30. FIG. 3 shows apparatus 10 without case 40 or notebook 50. Frame 20 may be characterized simply by rib 22 and an interior portion 32 of handles 30, as discussed in more detail below with respect to FIG. 5.

FIG. 4 is a cross-sectional view of apparatus 10 along line 4-4 of FIG. 2. As shown in FIG. 4, rib 22 may be embedded with body portion 42 of case 40, thereby unitizing rib 22 and case 40. Rib 22 may be embedded in body portion 42 during an injection molding process. Embedding rib 22 in body portion 42 allows handles 30 to be securely integrated with case 40, thereby providing strength to apparatus 10 for securing and holding notebook 50. Rib 22 may have a relatively flat profile, i.e., a small thickness, so that case 40 does not protrude a large distance from the backside of notebook 50.

In FIG. 4, gripping portions 46 of peripheral edges 44 are shown wrapped around notebook edges 52 of notebook 50. The shaded portions of body portion 42, peripheral edges 44, and gripping portions 46 are surfaces exposed by a plane of the cross-sectional cut. The un-shaded portions represent portions visible at a distance from the plane of the cross-sectional cut. One of the handles 30 is visible behind case 40 and notebook 50.

FIG. 5 is a cross-sectional view of one of the handles 30 along line 5-5 of FIG. 2. As shown in FIG. 5, handle 30 may include an interior portion 32 and a grip surface 34. Grip surface 34 may extend around a full circumference of interior portion 32. Interior portion 32 may be formed of the same material as rib 22 and may be formed simultaneously with rib 22 together as one integral part. Thus, interior portion 32 may be formed as a unitary structure with rib 22, the two features together comprising frame 20. Interior portion 32 provides overall strength to apparatus 10, and if apparatus 10 is dropped or collides with an object, can absorb at least some of the impact, thereby protecting notebook 50.

Grip surface 34 may be added to interior portion 32 for user comfort, protection of notebook 50, and to reduce a risk of dropping apparatus 10. For example, grip surface 34 may be made with a foam, rubber, or rubber-like material which provides elasticity to handles 30. The elasticity of handles 30 may provide comfort to a user's hands when gripping handles 30, and may absorb impact in case apparatus 10 is dropped or collides with an object.

The rubber or rubber-like material of grip surface 34 may increase a coefficient of friction between the user's hands and handles 30, thereby decreasing a likelihood of the user dropping apparatus 10. Grip surface 34 may be textured for improved grip by the user, for example with an open cell pattern. A thickness of grip surface 34 may be selected to provide an ideal handle diameter for a human hand, thereby increasing the user's comfort when using apparatus 10.

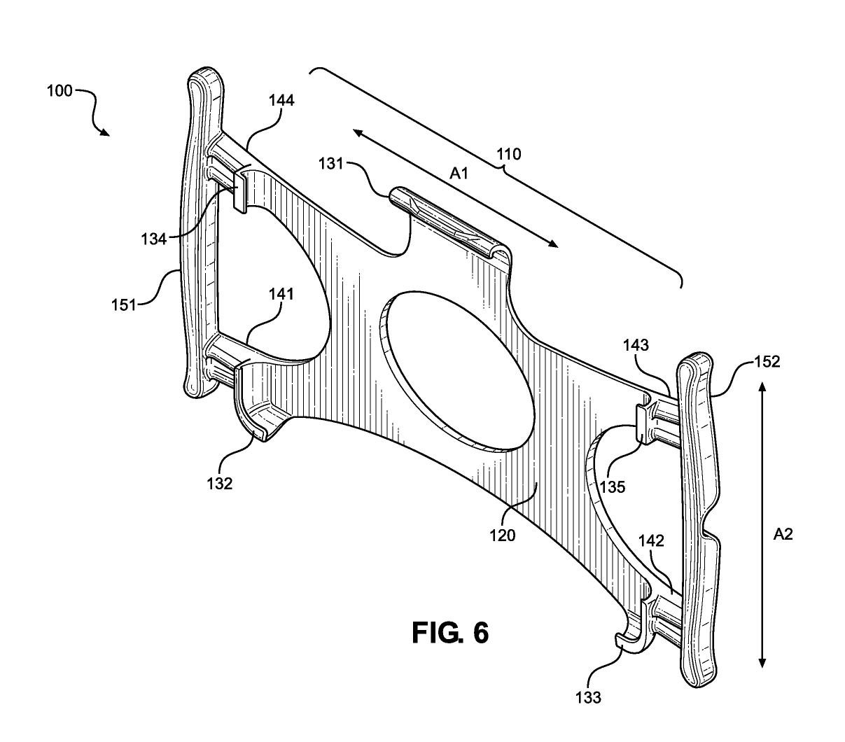

FIG. 6 is a perspective view of an exemplary apparatus according to a second aspect of the invention. As shown in FIG. 6, apparatus 100 may include a body 110, connectors 141, 142, 143 and 144, and handles 151 and 152. Body 110 may include a planar portion 120 and gripping portions 131, 132, 133, 134 and 135. Because apparatus 100 may contain any number of plural gripping portions, the gripping portions may be collectively referred to hereinafter as “gripping portions 130”. Similarly, when general characteristics of the gripping portions are explained, but without reference to a specific gripping portion, the term “gripping portion 130” may be used.

As shown in FIG. 6, gripping portions 130 may each extend from a respective part of a periphery of the planar portion 120. The gripping portions 130 may extend in a direction transverse to the planar portion 120 (e.g., transverse to a plane of the planar portion 120). First connector 141 may extend between body 110 and first handle 151. Second connector 142 may extend between body 110 and second handle 152 at an opposite side of body 110 from first handle 151. Handles 151, 152 may be surrounded fully or partially by a layer of material to increase comfort and/or grip of handles 151, 152 (e.g., an open cell type foam, rubber, or similar material).

Apparatus 100 may comprise a first connector 141 extending along a first axis A1 substantially parallel with the planar portion 120. Apparatus 100 may comprise a first handle 151 extending along a second axis A2 substantially parallel with the planar portion 120 and substantially perpendicular to the first axis A1, the first connector 141 extending between the body 110 and the first handle 151. The structure or apparatus 100 may thus be removably secured to a notebook 160 by gripping edges 161 of the notebook with gripping portions 130 so that the notebook 160 may be manipulated and handled by the first handle 151 of the structure.

Apparatus 100 may be a unitary structure. For example, apparatus 100 may not be pieced together from component parts, but rather formed as a single piece. Apparatus 100 may comprise a homogenous flexible solid, or in fact, may consist essentially of the homogenous flexible solid. For example, apparatus 100 may be formed of a single mold (e.g., plastic, polyurethane, or rubber). Apparatus 100 may be formed by an injection molding process (e.g., a one-piece injection). By forming apparatus 100 of a one-piece homogenous flexible solid, the formation of apparatus 100 may be simplified in a low cost manufacturing process.

FIG. 6 shows that body 110 may comprise first, second, third, fourth, and fifth gripping portions 131-135. However, body 110 may simply comprise first, second, and third gripping portions 131, 132, and 133. First gripping portion 131 may extend linearly along the first axis A1. Second gripping portion 132 may have an L-shape extending along the first axis A1 and the second axis A2. Third gripping portion 132 may have an L-shape extending along the first axis A1 and the second axis A2.

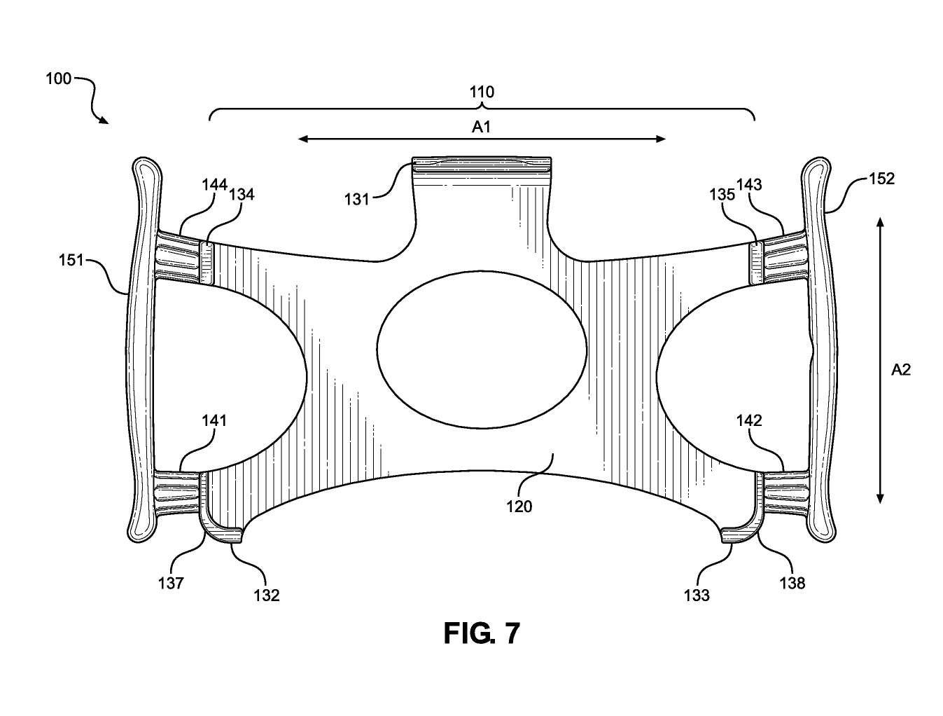

A first distance may be defined as the distance between (i) a section of the second gripping portion 132 along the second axis A2, and (ii) a section of the third gripping portion 133 along the second axis A2. A second distance may be defined as a distance between (i) the first gripping portion 131, and (ii) a midpoint between a corner 137 of the second gripping portion 132 and a corner 138 of the third gripping portion 133 (see FIG. 7). In general, apparatus 100 is designed to accommodate a standard tablet or other computing device (e.g., in a substantially rectangular shape). Thus, the first distance may be less than 80 percent (or 70, 60, or 50 percent) of the second distance or vice versa (e.g., the second distance may be less than 80, 70, 60, or 50 percent of the first distance).

In general, functional components of notebook 160 remain exposed or unobscured by gripping portions 130. This may allow for full functionality or at least a high degree of functionality of notebook 160 while engaged with apparatus 100. Therefore, a length of first gripping portion 131 along the first axis A1 may be less than 50 percent (or 40, 30, or 20 percent) of a length of body 110 along the first axis A1. Furthermore, the section of second gripping portion 132 along the first axis A1, and the section of third gripping portion 133 along the first axis A1, may be spaced apart by a distance greater than 50 percent (or 60, 70, or 80 percent) of the length of the body along the first axis A1, and there may be no gripping portions 130 directly in between second gripping portion 132 and third gripping portion 133. For example, there may be no gripping portion at an opposite side of body 110 from gripping portion 131 (other than gripping portions 132, 133).

FIG. 7 is a front view of exemplary apparatus 100. As shown in FIG. 7, second gripping portion 132 may have a corner 137. Corner 137 may represent a junction between (i) a section of second gripping portion 132 extending along the first axis A1, and (ii) a section of second gripping portion 132 extending along the second axis A2. Similarly, third gripping portion 132 may have a corner 138. Corner 138 may represent a junction between (i) a section of third gripping portion 133 extending along the first axis A1, and (ii) a section of second gripping portion 133 extending along the second axis A2.

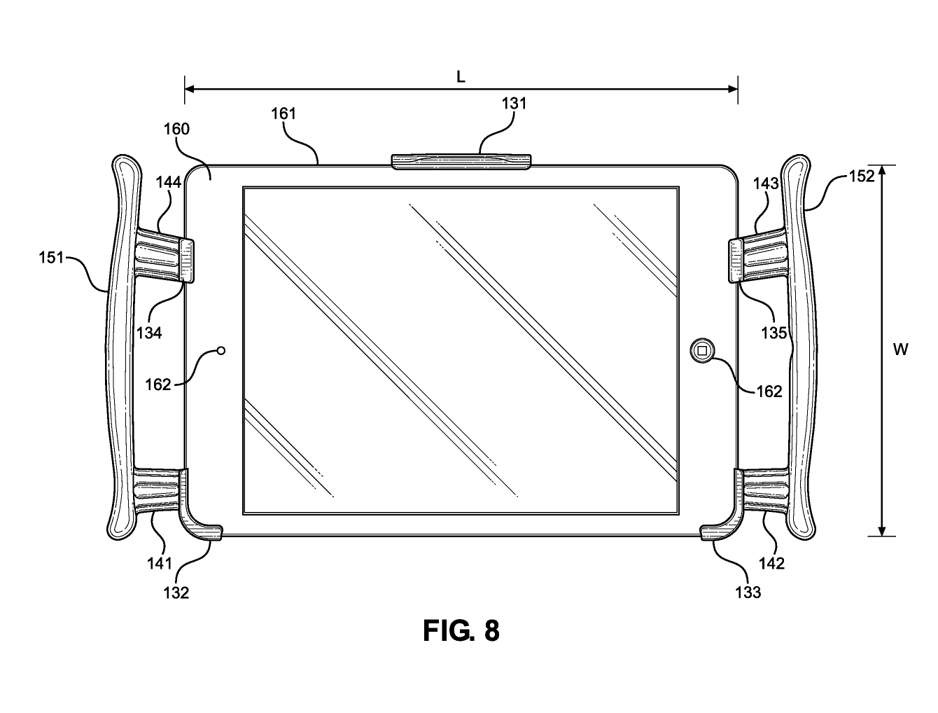

FIG. 8 is a front view of exemplary apparatus 100 engaged with notebook 160. As shown in FIG. 8, notebook 160 may include an edge 161 and functional components 162. Functional components 162 may include a camera lens, a speaker, buttons, a headphone jack, or other such elements of notebook 160. Gripping portions 131-135 may receive and grip notebook 160 at locations along notebook edge 161.

As shown in FIG. 8, notebook 160 may be substantially rectangular and have a length L and a width W. Length L may extend along the first axis A1and width W may extend along the second axis A2. However, variations are contemplated in which length L may extend along the second axis A2 and width W may extend along the first axis A1. In such variations, the handles 151 and 152 may be located at the longer sides of the notebook. Additional variations are contemplated in which a third, and even fourth, handle are provided, for example, a handle for each of the four sides of the rectangular notebook 160.

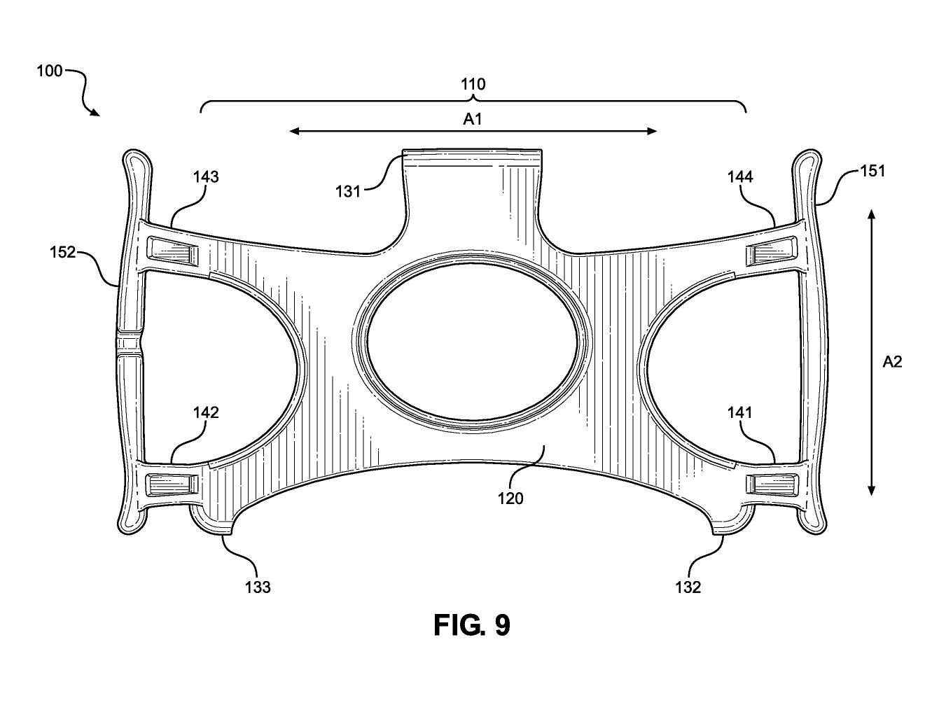

FIG. 9 is a rear view of exemplary apparatus 100. As shown in FIG. 9, planar portion 120 may include a central circular or oval-shaped opening. Such opening may allow for a logo of the notebook 160 to remain visible when apparatus 100 is engaged with notebook 160. The opening may also decrease a weight of apparatus 100 while not significantly diminishing its strength and structural integrity.

As shown in FIG. 9, a rear side of connectors 141-144 may be flush with their respective sections of the planar portion 120 from which they extend. This feature may add strength to the overall structure and may simplify the manufacturing process.

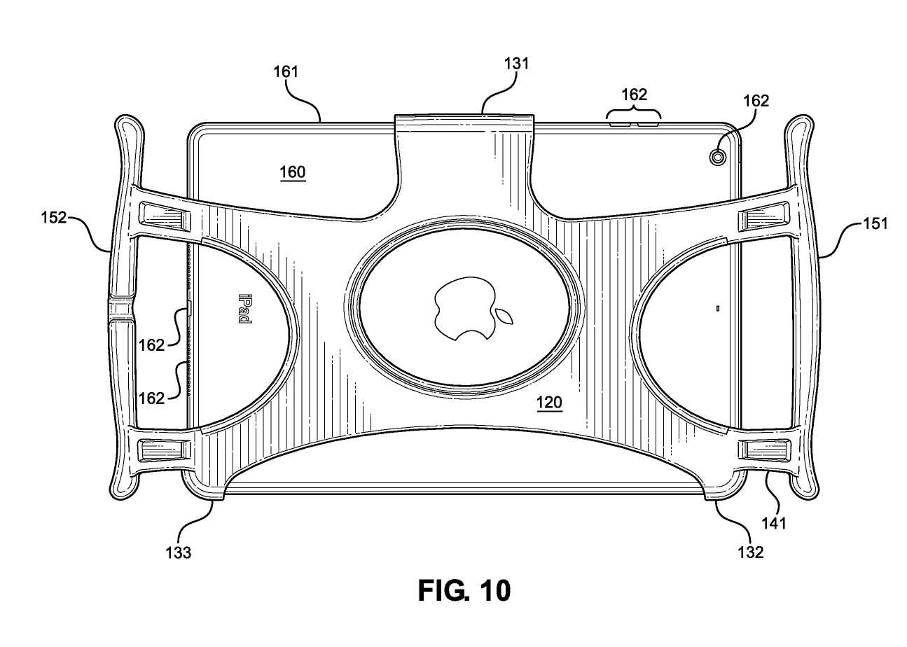

FIG. 10 is a rear view of exemplary apparatus 100 engaged with notebook 160. As shown in FIG. 10, functional components 162 may be located at a rear side of notebook 160 and/or along notebook edge 161. In general, functional components 162 remain exposed (are not covered or obscured) by gripping portions 130. Leaving functional components 162 exposed permits full use (or nearly full use) of notebook 160 while engaged with apparatus 100.

In one aspect of the invention, locations of gripping portions 130 and locations of functional components 162 are mutually exclusive (e.g., do not coincide with each other). In another aspect of the invention, one or more gripping portions 130 may partially cover one or more functional components 162. A design choice may be made in which a functional component (or portion thereof) 162 (e.g., a speaker) is covered by one of the gripping portions 130. In this case, it may be determined that the reduction in functionality is acceptable due to the improved security imparted by the location of the gripping portion 130.

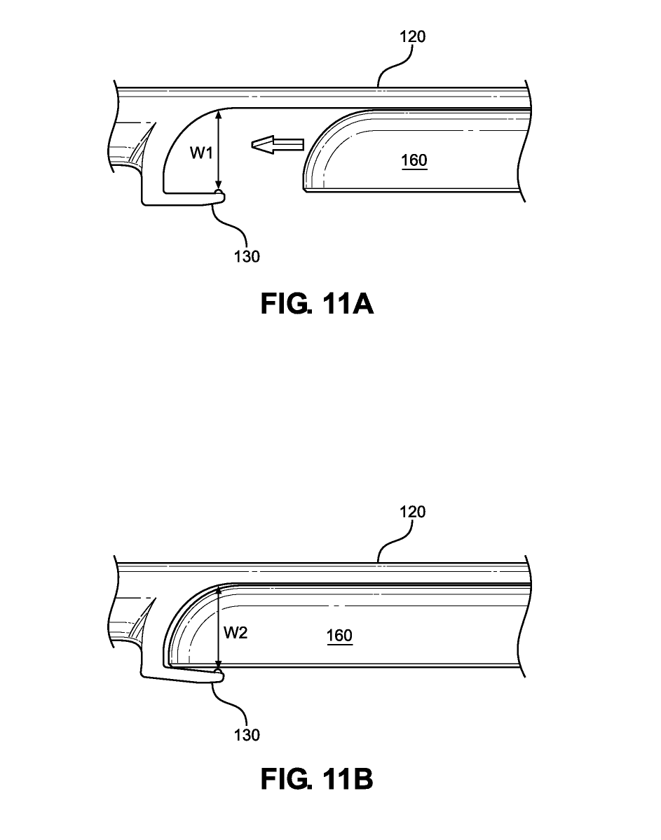

FIG. 11A is a cross-sectional view of an exemplary gripping portion 130. As shown in FIG. 11A, gripping portion 130 extends transversely to a plane of planar portion 120. Gripping portion 130 may include a projection which is substantially parallel to planar portion 120. Gripping portion 130 together with the section of planar portion 120 from which it extends may form a C-shape capable of receiving an edge of notebook 160. The C-shape may have a first interior width W1 when notebook 160 is not engaged with apparatus 100. The first interior width W1 may be less than a thickness of the edge of notebook 160.

FIG. 11B is a cross-sectional view of exemplary gripping portion 130 when notebook 160 is engaged with apparatus 100. As shown in FIG. 11B, a material of gripping portion 130 is generally of sufficient flexibility to permit the first interior width W1 to expand to a second interior width W2 when notebook 160 is engaged with apparatus 100. Second interior width W2 may represent a full thickness of notebook 160 or a thickness along an edge of notebook 160 where the thickness tapers (e.g., less than a full thickness of notebook 160).

A raised profile or “bump” at the end of gripping portion 130 may assist in engaging notebook 160 with apparatus 100. For example, pressure (e.g., lateral pressure from the perspective of FIGS. 11A-B, or a force substantially parallel to the plane of planar portion 120) upon the raised profile or “bump” by notebook 160 may force the expansion of the C-shaped profile.

A material of gripping portion 130 may be a same material of which the entire apparatus 100 may be formed (e.g., a homogenous flexible solid). The flexibility of the material may allow apparatus 100 to be removably secured to notebook 160 by compressive force exerted upon edges 161 of notebook 160 when the apparatus 100 is engaged with the notebook 160. However, the material may be of limited flexibility (e.g., still has a significant degree of rigidity) to provide strength to apparatus 100.

In another aspect of the invention, the projection of gripping portion 130 may be angled slightly upward with respect to planar portion 120 (e.g., projecting towards planar portion 120) when notebook 160 is engaged with apparatus 100. In this case, the projection may be substantially parallel to planar portion 120 when notebook 160 is engaged with apparatus 100. Various combinations of angles of the projection are possible with respect to the engaged and non-engaged states of apparatus 100.

Embodiments of the subject apparatus and method have been described herein. Nevertheless, it will be understood that various modifications may be made without departing from the spirit and understanding of this disclosure. Accordingly, other embodiments and approaches are within the scope of the following claims.

What is claimed is:

1. An apparatus for use with a notebook, the apparatus comprising:
a frame having opposing handles oriented in a first direction, the handles mutually spaced apart and joined by a connecting rib, the connecting rib oriented in a second direction;
a case having a body portion with a peripheral edge;
the case further having plural gripping means integral with, and extensive from, the peripheral edge;
the connecting rib of the frame embedded in the body portion of the case thereby unitizing the case and the connecting rib;
whereby the case may be removably secured to the notebook by gripping edges of the notebook with the gripping means of the case so that the notebook may be manipulated and handled by the handles of the frame.

2. The apparatus of claim 1, wherein the second direction is perpendicular to the first direction.

3. An apparatus for use with a notebook, the apparatus comprising:
a frame having a handle oriented in a first direction, the handle joined to a case by a connecting rib, the connecting rib oriented in a second direction;
the case having a body portion with a peripheral edge;
the case further having plural gripping means integral with, and extensive from, the peripheral edge;
the connecting rib of the frame embedded in the body portion of the case thereby unitizing the case and the connecting rib;
whereby the case may be removably secured to the notebook by the gripping edges of the notebook with the gripping means of the case so that the notebook may be manipulated and handled by the handle of the frame.

4. The apparatus of claim 3, wherein the second direction is perpendicular to the first direction.

5. A notebook, frame, and case combination, comprising:
the notebook having a first pair of edges oriented in a first direction and a second pair of edges oriented in a second direction;
the frame having opposing handles oriented in the first direction, the handles mutually spaced apart and joined by a connecting rib, the connecting rib oriented in the second direction;
the case having a body portion with a peripheral edge;
the case further having plural gripping means integral with, and extensive from, the peripheral edge;
the connecting rib of the frame embedded in the body portion of the case thereby unitizing the case and the connecting rib;
the case removably secured to the notebook by gripping at least one of the first and second pairs of edges of the notebook with the gripping means of the case so that the notebook may be manipulated and handled by the handles of the frame.

6. The combination of claim 5, wherein the second direction is perpendicular to the first direction.

7. The combination of claim 5, wherein the case is removably secured to the notebook by gripping both of the first and second pairs of edges of the notebook with the gripping means of the case so that the notebook may be manipulated and handled by the handles of the frame.

8. A unitary structure comprising a body, a first connector, and a first handle, wherein:
the body comprises a planar portion and gripping portions, the gripping portions extending from a periphery of the planar portion in a first direction transverse to the planar portion;
the first connector extends from the periphery of the planar portion along a first axis substantially parallel with the planar portion; and
the first handle extends along a second axis (i) substantially parallel with the planar portion and (ii) substantially perpendicular to the first axis, the first connector extending between the body and the first handle;
whereby the structure may be removably secured to a notebook by gripping edges of the notebook with the gripping portions so that the notebook may be manipulated and handled by the first handle of the structure.

9. The structure of claim 8, wherein:
the body comprises first, second, and third gripping portions;
the first gripping portion is linear along the first axis;
the second and third gripping portions each have an L-shape along the first and second axes;
a section of the second gripping portion along the second axis and a section of the third gripping portion along the second axis are spaced apart from each other by a first distance; and
a second distance is defined by a distance between (i) the first gripping portion and (ii) a midpoint between corners of the second and third gripping portions, wherein either (i) the second distance is less than 80 percent of the first distance or (ii) the first distance is less than 80 percent of the second distance.

10. The structure of claim 9, wherein:
the length of the first gripping portion along the first axis is less than 50 percent of the length of the body along the first axis; and
a section of the second gripping portion along the first axis and a section of the third gripping portion along the first axis (i) are spaced apart by a distance greater than 50 percent of the length of the body along the first axis and (ii) have no directly intervening gripping portions;
whereby functional components of the notebook may remain exposed or unobscured by the gripping portions.

11. The structure of claim 8, wherein the structure consists essentially of a homogenous flexible solid.

12. The structure of claim 11, wherein:
each gripping portion and corresponding part of the planar portion from which it extends together form a C-shape having a first interior width when the structure is not engaged with the notebook; and
the homogenous flexible solid is of sufficient flexibility to permit each C-shape to have a second interior width greater than the first interior width when the structure is engaged with the notebook;
whereby the structure may be removably secured to the notebook by compressive force exerted upon the edges of the notebook when the structure is engaged with the notebook.

13. The structure of claim 8, further comprising a second connector and a second handle, wherein:
the second connector extends from the periphery of the planar portion along the first axis at a location of the periphery opposite from the first connector; and
the second handle extends along the second axis at a side of the body opposite from the first handle, the second connector extending between the body and the second handle;
whereby the notebook may be manipulated and handled by the first and second handles of the structure.

14. A structure and notebook combination comprising the structure of claim 8 and the notebook.

15. The combination of claim 14, wherein when the structure is engaged with the notebook, locations of functional components of the notebook and locations of gripping portions of the structure are mutually exclusive.

16. The combination of claim 14, wherein:
the notebook has a length along the first axis, a width along the second axis, and a thickness;
the structure comprises first, second, and third gripping portions;
the first gripping portion is linear along the first axis;
the second and third gripping portions each have an L-shape along the first and second axes;
a section of the second gripping portion along the second axis and a section of the third gripping portion along the second axis are spaced apart from each other by a distance substantially equal to the length of the notebook; and
a distance between (i) the first gripping portion and (ii) a midpoint between corners of the second and third gripping portions is substantially equal to the width of the notebook.

17. The combination of claim 16, wherein the structure comprises fourth and fifth gripping portions each linear along the second axis and spaced apart from each other by a distance substantially equal to the length of the notebook.

18. The combination of claim 14, wherein:
the structure consists essentially of a homogenous flexible solid;
each gripping portion and corresponding part of the planar portion from which it extends together form a C-shape having a first interior width less than a thickness of the edge of the notebook when the structure is not engaged with the notebook; and
the homogenous flexible solid is of sufficient flexibility to permit each C-shape to have a second interior width equal to the thickness of the edge of the notebook when the structure is engaged with the notebook;
whereby the structure may be removably secured to the notebook by compressive force exerted upon the edges of the notebook when the structure is engaged with the notebook.
